(19) United States
(12) Patent Application Publication
(10) Pub. No.: US 2026/0225260 A1
(43) Pub. Date: Aug. 6, 2026

(54) INFORMATION PROCESSING APPARATUS AND INFORMATION PROCESSING METHOD

(71) Applicant: Sony Group Corporation, Tokyo (JP)

(72) Inventors: Kazumi AOYAMA, Saitama (JP); Tokuhiro NISHIKAWA, Tokyo (JP); Shunichi SEKIGUCHI, Kanagawa (JP)

(73) Assignee: Sony Group Corporation, Tokyo (JP)

(21) Appl. No.: 19/149,850

(22) PCT Filed: Jan. 9, 2024
(86) PCT No.: PCT/JP2024/000123

§ 371 Date: Jul. 22, 2025

(30) Foreign Application Priority Data
Feb. 28, 2023 (JP) 2023-029076

(51) Int. Cl. B25J 13/00; B25J 13/08

(52) U.S. Cl. CPC B25J 13/003; B25J 13/08

(57) ABSTRACT

A target object can be uniquely represented with simpler language expression.

An information processing apparatus includes an image evoking unit that extracts a registered object from a captured image and outputs an identifier corresponding to the extracted object, a name object registration unit that registers a correspondence between a name of the object and the identifier, and an overall control unit that grasps a correspondence between the name included in an instruction text and the object included in the captured image on a basis of the identifier and executes an operation on the object instructed by the instruction text.

### TECHNICAL FIELD

The present disclosure relates to an information processing apparatus and an information processing method.

### BACKGROUND ART

Language is a means by which humans can freely communicate their intentions without special training. Therefore, language is expected as an interface for instructing a robot capable of executing various tasks to perform an operation.

For example, Patent Document 1 below discloses an entertainment robot that learns a user's face and name by interaction with language (that is, conversation).

### CITATION LIST

### Patent Document

Patent Document 1: Japanese Patent Application Laid-Open No. 2004-252111

### SUMMARY OF THE INVENTION

### Problems to be Solved by the Invention

Language can represent objects in a variety of expressions. Therefore, in a case where the user instructs the robot to manipulate an object, it is important to designate a target object with a language expression uniquely representing the object and to recognize the same object as the target object between the user and the robot. However, it is a heavy burden for the user that the user considers the language expression of the object that can be distinguished from other objects whenever the user instructs the manipulation of the object.

Therefore, a technology capable of uniquely representing the target object with simpler language expression has been desired.

### Solutions to Problems

According to the present disclosure, there is provided an information processing apparatus including an image evoking unit that extracts a registered object from a captured image and outputs an identifier corresponding to the extracted object, a name object registration unit that registers a correspondence between a name of the object and the identifier, and an overall control unit that grasps a correspondence between the name included in an instruction text and the object included in the captured image on a basis of the identifier and executes an operation on the object instructed by the instruction text.

Furthermore, according to the present disclosure, there is provided an information processing method including extracting a registered object from a captured image and outputting an identifier corresponding to the extracted object, registering a correspondence between a name of the object and the identifier, and grasping a correspondence between the name included in an instruction text and the object included in the captured image on a basis of the identifier and causing an operation on the object instructed by the instruction text to be executed.

### BRIEF DESCRIPTION OF DRAWINGS

FIG. 1 is an explanatory diagram illustrating an outline of an information processing apparatus according to an embodiment of the present disclosure.

FIG. 2 is a block diagram illustrating a functional configuration of the information processing apparatus according to the present embodiment.

FIG. 3 is a flowchart illustrating a flow of a first operation example of the information processing apparatus.

FIG. 4 is a block diagram illustrating a flow of data of the first operation example.

FIG. 5 is a flowchart illustrating a flow of a second operation example of the information processing apparatus.

FIG. 6 is a block diagram illustrating a flow of data of the second operation example in a case where a target object is specified by a name.

FIG. 7 is a block diagram illustrating a flow of data of the second operation example in a case where the target object is specified by an expression other than the name.

FIG. 8 is a block diagram illustrating a hardware configuration example of the information processing apparatus according to the present embodiment.

### MODE FOR CARRYING OUT THE INVENTION

A preferred embodiment of the present disclosure will be described below in detail, with reference to the accompanying drawings. Note that, in the present specification and drawings, components having substantially the same functional configuration are denoted by the same reference signs, and repetitive explanations are not made.

Note that, the description will be given in the following order.
1. Outline
2. Configuration of Information Processing Apparatus
3. Operation of Information Processing Apparatus
3.1. First Operation Example
3.2. Second Operation Example
4. Hardware Configuration Example

### 1. Outline

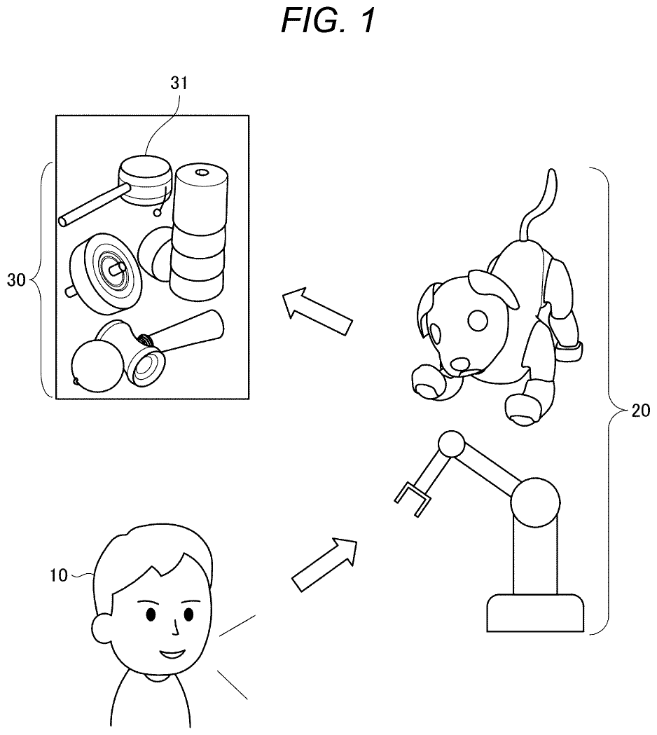

An outline of the technology according to the present disclosure will be described with reference to FIG. 1. FIG. 1 is an explanatory diagram illustrating an outline of an information processing apparatus according to an embodiment of the present disclosure.

As illustrated in FIG. 1, in a case where a user 10 instructs a robot 20 to manipulate an object 30 in a natural language such as an utterance, the user 10 is required to select a language expression uniquely representing a target object 31 from among a large number of operable objects 30.

The robot 20 is, for example, a manipulator robot capable of holding the object 30, a mobile manipulator robot capable of holding and moving the object 30, a single-arm or double-arm arm robot, a pet-type robot, a humanoid robot, or the like. These robots 20 can be used for object manipulation such as bringing an object or tidying up an object in a home where there are various objects 30, for example.

Furthermore, the robot 20 may be a presence in a virtual space having no entity. For example, the robot 20 may be a machine, a robot, an agent, or a non-player character (NPC) present in the virtual space. The user 10 may instruct the robot 20 in the virtual space to manipulate the object 30 in a natural language such as utterance.

For example, a scene in which the target object 31 is brought to the robot 20 from among the plurality of objects 30 placed in a field of view of the robot 20 is assumed. In such a case, the user 10 considers in what language expression the target object 31 is to be expressed to cause the robot 20 to accurately recognize the target object 31, and then instructs the robot 20 to manipulate the object in utterance. However, considering the complexity of an environment in which the robot is used, it cannot be said that the target object 31 can constantly be designated with a relatively simple language expression, such as “ball” or “cop”.

Considering complex language expression that can distinguish the target object 31 from other objects in such a situation can be a stress factor for the user 10. Furthermore, in practice, even though the user 10 intends to express the target object 31 in an expression distinguishable from other objects, there may be a case where the target object 31 cannot be distinguished from other objects and there are a plurality of candidates for the target object, or a case where the target object 31 is not accurately expressed. It is assumed that specifying the target object 31 by the robot 20 in such a situation is more difficult and less accurate than specifying an object that can be expressed in simple language expression.

The technology according to the present disclosure has been conceived in view of the above circumstances. The information processing apparatus according to the present embodiment associates and registers a name of the target object 31 taught to the robot 20 by the user 10 and an image of the target object 31, and thus, the user 10 can instruct the robot 20 to perform an operation on the target object 31 by using the name. Accordingly, the name of the target object 31 is taught to the robot 20, and thus, the user 10 can uniquely specify the target object 31 without a complex expression. Therefore, since the information processing apparatus according to the present embodiment can reduce diversity and ambiguity in expressing the target object 31 in language, it is possible to improve a probability that the robot 20 will succeed in a task instructed by the user 10.

### 2. Configuration of Information Processing Apparatus

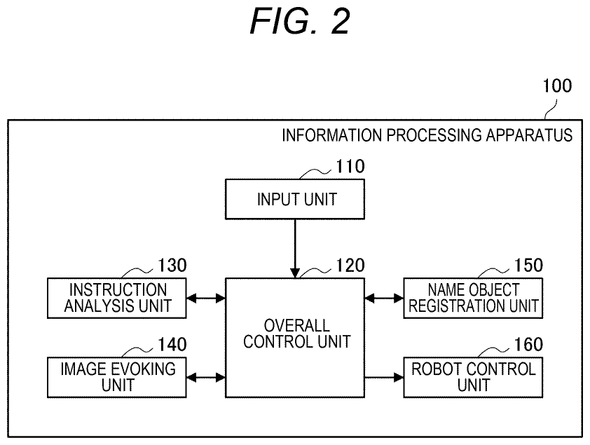

A functional configuration of the information processing apparatus according to the present embodiment will be described with reference to FIG. 2. FIG. 2 is a block diagram illustrating the functional configuration of the information processing apparatus 100 according to the present embodiment.

As illustrated in FIG. 2, the information processing apparatus 100 includes an input unit 110, an overall control unit 120, an instruction analysis unit 130, an image evoking unit 140, a name object registration unit 150, and a robot control unit 160. The information processing apparatus 100 is mounted on, for example, the robot 20 or the like. The information processing apparatus 100 can cause the robot 20 to perform an operation instructed by utterance voice or text from the user 10.

The input unit 110 receives various kinds of information input from an outside. Specifically, the input unit 110 may receive an instruction text to the robot 20. The instruction text is an operation instruction to the robot 20 expressed in a natural language. The instruction text may be, for example, a text obtained by voice recognition of a voice uttered by the user 10 or a text input by the user 10 by using a keyboard or the like.

Furthermore, the input unit 110 may receive, as an input image, an image captured by an imaging device mounted on the robot 20. The information processing apparatus 100 can cause the robot 20 to perform the operation on the target object 31 instructed by the instruction text by comparing the target object 31 appearing in the input image with the content indicated by the instruction text.

The overall control unit 120 executes control and determination in the information processing apparatus 100. Specifically, in cooperation with the instruction analysis unit 130, the image evoking unit 140, and the name object registration unit 150, the overall control unit 120 grasps the content of the operation on the target object 31 instructed by the input instruction text, and outputs a drive command for performing the grasped operation to the robot control unit 160. The robot control unit 160 controls the drive of each unit of the robot 20 on the basis of the output drive command, and thus, the robot 20 can execute the operation on the target object 31 instructed by the instruction text.

The instruction analysis unit 130 analyzes the instruction text expressed in the natural language to specify a category of the operation instructed by the user 10 and the target object 31 of the instructed operation. Specifically, the instruction analysis unit 130 may analyze the instruction text by using a known text analysis technology to specify the category of the operation instructed by the instruction text and the target object 31 of the operation. For example, the instruction analysis unit 130 may specify the category of the operation instructed by the instruction text as one of four types of “naming target object 31”, “transporting target object 31 below user 10”, “placing target object 31 at designated place”, and “no operation instruction”.

Furthermore, the instruction analysis unit 130 may specify the target object 31 of the operation instructed by the instruction text from the input image, may cut out an image region including the specified target object 31 from the input image, and may output the image region. For example, in a case where the target object 31 is specified by a color, a shape, or a language expression such as a general noun in the instruction text, the instruction analysis unit 130 may specify, as the target object 31, an object corresponding to the language expression from the input image and may output the image region including the target object 31. Furthermore, in a case where there is only one object appearing in the input image, or in a case where it is clear that a specific object is indicated in the input image by pointing or the like of the user 10, the instruction analysis unit 130 may specify the object as the target object 31 and may output the image region including the target object 31.

On the other hand, in a case where the category of the operation instructed by the instruction text is “naming target object 31”, the instruction analysis unit 130 may further extract a name given to the target object 31 from the instruction text. In such a case, the instruction analysis unit 130 outputs the image region including the target object 31 to be named and the name given to the target object 31. The image region including the target object 31 is output to the image evoking unit 140 via the overall control unit 120, and the name given to the target object 31 is output to the name object registration unit 150 via the overall control unit 120.

The image evoking unit 140 registers images of various objects and identifiers in association with each other, and outputs an identifier corresponding to an object included in the input image. The identifier is, for example, a number, a code, a symbol, or the like for identification. Specifically, the image evoking unit 140 compares the input image with the images of the registered various objects, and in a case where the object in the input image matches any of the registered various objects, the image evoking unit outputs an identifier corresponding to the matched object and an image region including the object in the input image. On the other hand, in a case where the object in the input image does not match any of the registered various objects, the image evoking unit 140 newly registers an image region of the object in the input image and outputs a new identifier corresponding to the object.

The name object registration unit 150 registers a correspondence between the identifier output from the image evoking unit 140 in association with the object and the name of the object. Note that, the name object registration unit 150 may register one name in association with the identifier, or may register two or more names in association with the identifier. In a case where the name of the object for which the correspondence is registered is input, the name object registration unit 150 outputs an identifier associated with the input name of the object. Furthermore, conversely, in a case where the identifier corresponding to the target object 31 is input, the name object registration unit 150 may output the name of the object associated with the input identifier.

On the other hand, in a case where the category of the operation instructed by the instruction text is “naming target object 31”, the name object registration unit 150 registers a correspondence between the name given to the target object 31 and the identifier output by the image evoking unit 140 in association with the target object 31. Thereafter, the name object registration unit 150 outputs information indicating that the registration of the correspondence is completed to the overall control unit 120.

The robot control unit 160 controls the driving of each unit of the robot 20 on the basis of the output from the overall control unit 120. Specifically, the robot control unit 160 controls the driving of each unit so as to cause the robot 20 to execute the operation on the target object 31 instructed by the instruction text on the basis of the category of the operation instructed by the instruction text and the image region including the target object 31. For example, the robot control unit 160 may control driving of a manipulator or a moving mechanism of the robot 20 so as to execute the operation on the target object 31 instructed by the instruction text.

### 3. Operation of Information Processing Apparatus

### 3.1. First Operation Example

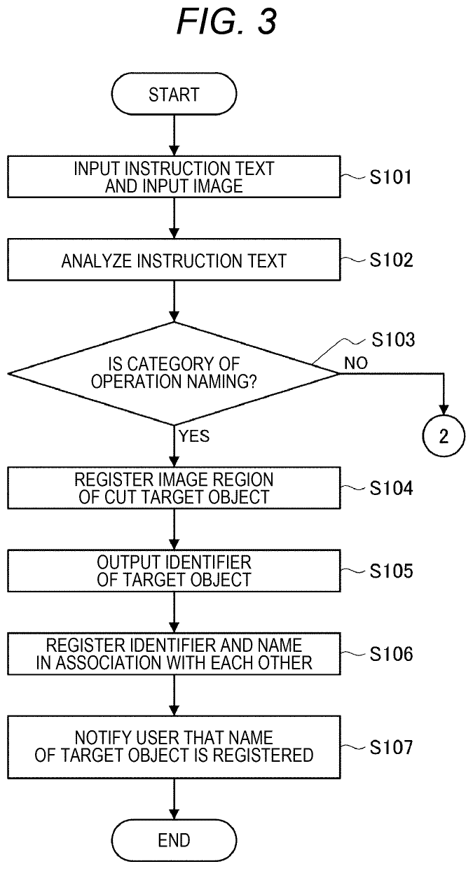

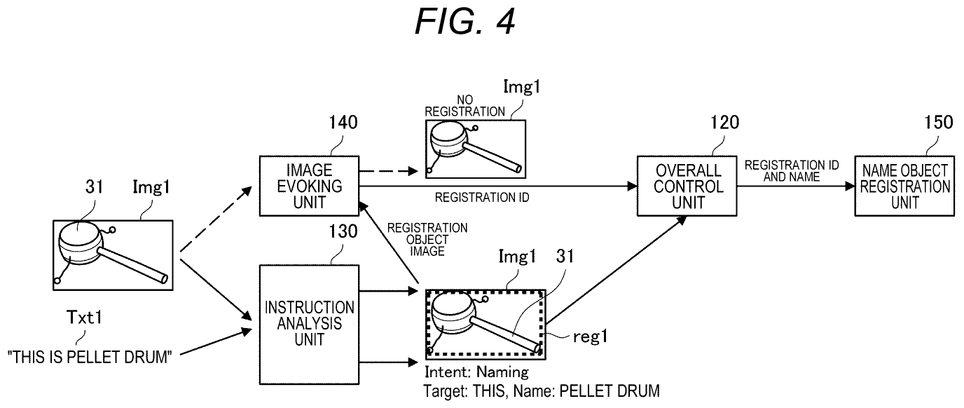

Next, a first operation example of the information processing apparatus 100 will be described with reference to FIGS. 3 and 4. FIG. 3 is a flowchart illustrating a flow of the first operation example of the information processing apparatus 100. FIG. 4 is a block diagram illustrating a flow of data of the first operation example.

The first operation example is an operation example in a case where the operation instructed by the instruction text is “naming target object 31”.

As illustrated in FIGS. 3 and 4, first, an instruction text Txt1 and an input image Img1 are input to the information processing apparatus 100 (S101). The instruction text Txt1 is an operation instruction to the robot 20 represented by a character string “this is pellet drum”. The input image Img1 is an image of the target object 31.

Next, the instruction analysis unit 130 analyzes the instruction text Txt1 (S102). Therefore, the instruction analysis unit 130 outputs the fact that the category of the operation instructed by the instruction text Txt1 is naming (Naming), that the target object 31 (Target) of the instructed operation is “this” (the object uniquely appearing in the image), and that the name (Name) given to the target object 31 is “pellet drum”.

On the other hand, in parallel with the operation of step S102, the input image Img1 is input to the image evoking unit 140. However, since the image of the target object 31 appearing in the input image Img1 is not registered in the image evoking unit 140, the image evoking unit 140 outputs a result of “not registered”.

Subsequently, the overall control unit 120 determines whether or not the category of the operation instructed by the instruction text Txt1 is naming (S103). In a case where the category of the instructed operation is naming (S103/Yes), the overall control unit 120 outputs a registered image region reg1 of the target object 31 cut out from the input image Img1 to the image evoking unit 140, and causes the image evoking unit 140 to register the image of the target object 31 in the registered image region reg1. Therefore, the image evoking unit 140 registers the image of the target object 31 in association with a new identifier (registration ID), and outputs the new identifier (registration ID) corresponding to the image of the target object 31 (S105).

Note that, a case where the category of the instructed operation is not naming (S103/No) will be described later in a second operation example.

Next, the overall control unit 120 outputs the identifier (registration ID) corresponding to the target object 31 issued from the image evoking unit 140 and a name “pellet drum” of the target object 31 to the name object registration unit 150. Therefore, the name object registration unit 150 registers a correspondence between the identifier (registration ID) corresponding to the target object 31 and the name “pellet drum” of the target object 31 (S106). Thereafter, the overall control unit 120 causes the robot 20 to notify the user 10 that the name of the target object 31 is registered via the robot control unit 160 (S107). For example, the robot 20 may notify the user 10 by using image display, light emission, voice, audio, or the like.

### 3.2. Second Operation Example

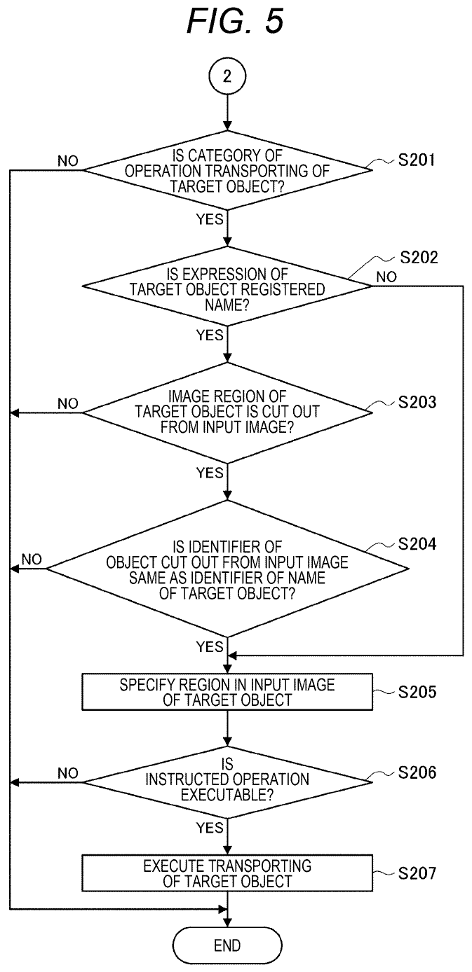

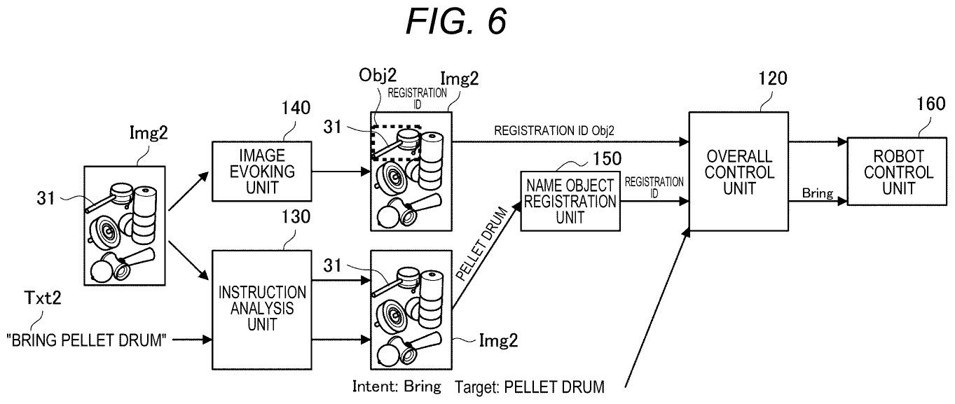

Next, the second operation example of the information processing apparatus 100 will be described with reference to FIGS. 3 and 5 to 7. FIG. 5 is a flowchart illustrating a flow of the second operation example of the information processing apparatus 100. FIG. 6 is a block diagram illustrating a flow of data of the second operation example in a case where the target object 31 is specified by the name.

The second operation example is an operation example in a case where the operation instructed by the instruction text is “transporting target object 31 below user 10” or “placing target object 31 at designated place”. In the second operation example to be described below, it is assumed that the fact that the name of the target object 31 is “pellet drum” is already registered in the information processing apparatus 100.

As illustrated in FIGS. 3 and 6, first, an instruction text Txt2 and an input image Img2 are input to the information processing apparatus 100 (S101). The instruction text Txt2 is an operation instruction to the robot 20 represented by a character string “bring pellet drum”. The input image Img2 is an image of a plurality of objects including the target object 31.

Next, the instruction analysis unit 130 analyzes the instruction text Txt2 (S102). Therefore, the instruction analysis unit 130 outputs the fact that the category of the operation instructed by the instruction text Txt2 is “transport (Bring)” and that the target object 31 (Target) of the instructed operation is “pellet drum”.

On the other hand, in parallel with the operation of step S102, the input image Img2 is input to the image evoking unit 140. Since the image of the target object 31 appearing in the input image Img2 is registered in the image evoking unit 140, the image evoking unit 140 outputs the identifier (registration ID) corresponding to the target object 31, and cuts out and outputs an image region Obj2 including the target object 31 from the input image Img2.

Subsequently, as illustrated in FIGS. 5 and 6, the overall control unit 120 determines whether or not the category of the operation instructed by the instruction text Txt2 is transporting of the target object 31 (S201).

In a case where the category of the instructed operation is the transporting of the target object 31 (S201/Yes), the overall control unit 120 determines whether or not the expression (pellet drum) of the target object 31 in the instruction text Txt2 is the name registered by the name object registration unit 150 (S202). In a case where the expression (pellet drum) of the target object 31 is the name registered by the name object registration unit 150 (S202/Yes), the overall control unit 120 receives an identifier (registration ID) associated with the name from the name object registration unit 150.

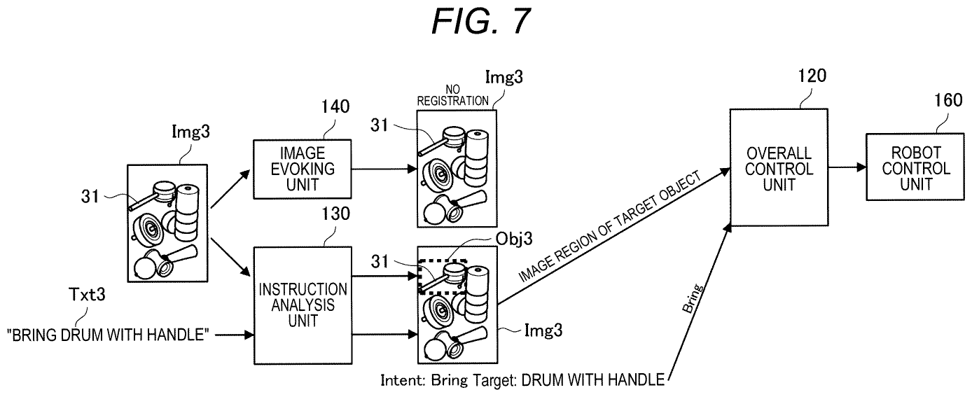

A case where the expression of the target object 31 in the instruction text Txt2 is not the name registered by the name object registration unit 150 (S202/No) will be described later with reference to FIG. 7.

On the other hand, the overall control unit 120 determines whether or not the image region Obj2 including the target object 31 is cut out from the input image Img2 by the image evoking unit 140 (S203). In a case where the image region Obj2 including the target object 31 is cut out from the input image Img2 (S203/Yes), the overall control unit 120 receives the image region Obj2 including the target object 31 and the identifier (registration ID) corresponding to the target object 31 from the image evoking unit 140.

Thereafter, the overall control unit 120 determines whether or not the identifier (registration ID) received from the name object registration unit 150 matches the identifier (registration ID) received from the image evoking unit 140 (S204). In a case where both the identifiers (registration IDs) match (S204/Yes), the overall control unit 120 determines that the target object 31 expressed as “pellet drum” in the instruction text Txt2 is the target object 31 included in the image region Obj2 of the input image Img2. Therefore, the overall control unit 120 can specify that the target object 31 expressed as “pellet drum” in the instruction text Txt2 is the target object 31 included in the image region Obj2 (S205).

As described above, since the category of the operation instructed by the instruction text Txt2 and the target object 31 of the instructed operation are specified, the overall control unit 120 determines whether or not the instructed operation is executable (S206). In a case where the instructed operation is executable, the overall control unit 120 causes the robot 20 to transport the target object 31 by driving each unit of the robot 20 via the robot control unit 160 (S207).

Note that, in a case where the overall control unit 120 determines No in any of the determinations of steps S201, S203, S204, and S206, the overall control unit 120 stops the execution of the operation instructed by the instruction text Txt2 and ends the operation.

In the above description, the name of the target object 31 in the instruction text Txt2 is input, and thus, the name object registration unit 150 outputs the identifier (registration ID) associated with the name. However, the technology according to the present disclosure is not limited to such an example.

For example, the identifier corresponding to the target object 31 output from the image evoking unit 140 is input, and thus, the name object registration unit 150 may output the name of the target object 31 associated with the input identifier. In such a case, the overall control unit 120 determines whether or not the name output from the name object registration unit 150 matches the name of the target object 31 in the instruction text Txt2. In a case where both the names match, the overall control unit 120 can specify that the target object 31 included in the image region Obj2 is the target object 31 expressed by the name in the instruction text Txt2, similarly to the above description.

A case where the expression of the target object 31 is not the name registered in the name object registration unit 150 (S202/No) will be described below with further reference to FIG. 7. FIG. 7 is a block diagram illustrating a flow of data of the second operation example in a case where the target object 31 is specified by an expression other than the name.

As illustrated in FIGS. 3 and 7, first, an instruction text Txt3 and an input image Img3 are input to the information processing apparatus 100 (S101). The instruction text Txt3 is an operation instruction to the robot 20 represented by a character string “bring drum with handle”. The input image Img3 is an image of a plurality of objects including the target object 31.

Next, the instruction analysis unit 130 analyzes the instruction text Txt3 (S102). Therefore, the instruction analysis unit 130 outputs the fact that the category of the operation instructed by the instruction text Txt3 is “transport (Bring)” and that the target object 31 (Target) of the instructed operation is “drum with handle”. At this time, since the instruction analysis unit can specify the target object 31 from the input image Img3 by the linguistic expression “drum with handle”, the instruction analysis unit 130 cuts out the image region Obj3 including the target object 31 corresponding to “drum with handle”.

On the other hand, in parallel with the operation of step S102, the input image Img3 is input to the image evoking unit 140. However, since the image of the target object 31 appearing in the input image Img3 is not registered in the image evoking unit 140, the image evoking unit 140 outputs a result of “not registered”.

Subsequently, as illustrated in FIGS. 5 and 7, the overall control unit 120 determines whether or not the category of the operation instructed by the instruction text Txt3 is transporting of the target object 31 (S201). In a case where the category of the instructed operation is the transporting of the target object 31 (S201/Yes), the overall control unit 120 determines whether or not the expression of the target object 31 in the instruction text Txt3 is the name registered in the name object registration unit 150 (S202).

As described above, the expression of the target object 31 in the instruction text Txt3 is not the name registered in the name object registration unit 150, but a general language expression of “drum with handle” (S202/No). Therefore, the overall control unit 120 can specify that the region including the target object 31 is the image region Obj3 from an output result of the instruction analysis unit 130 (S205).

As described above, since the category of the operation instructed by the instruction text Txt3 and the target object 31 of the instructed operation can be specified, the overall control unit 120 determines whether or not the instructed operation is executable (S206). In a case where the instructed operation is executable, the overall control unit 120 can cause the robot 20 to transport the target object 31 by driving each unit of the robot 20 via the robot control unit 160 (S207).

As described above, the information processing apparatus 100 according to the present embodiment registers the image of the target object 31 and the name of the target object 31 in association with each other, and thus, the target object 31 can be uniquely designated without complex language expression. Accordingly, since the information processing apparatus 100 can reduce diversity and ambiguity in language expression of the target object 31, it is possible to improve a probability that the robot 20 will succeed in the task instructed by the user 10.

### 4. Hardware Configuration Example

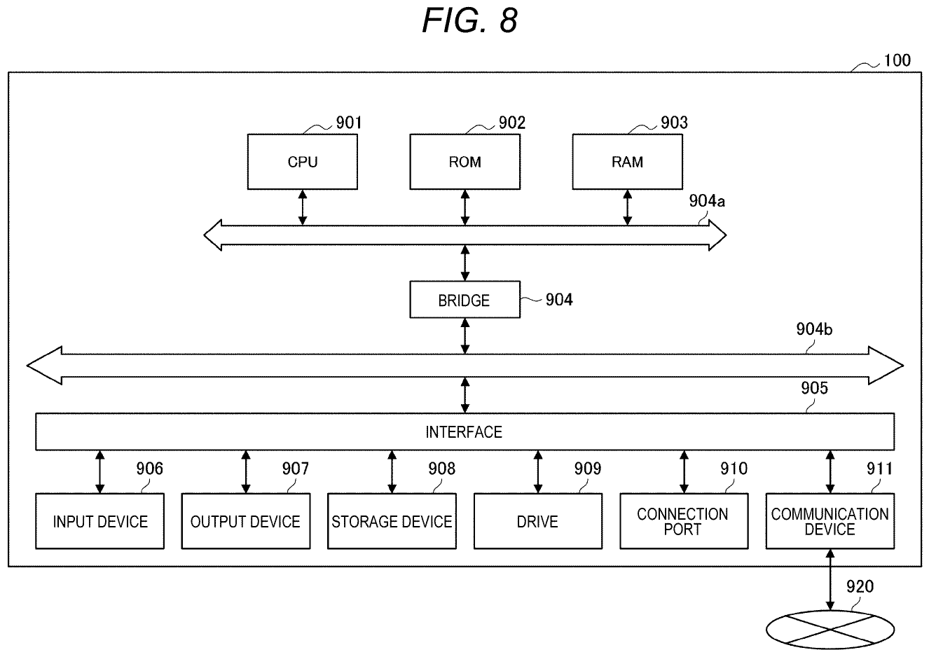

A hardware configuration of the information processing apparatus 100 according to the present embodiment will be described with reference to FIG. 8. FIG. 8 is a block diagram illustrating a hardware configuration example of the information processing apparatus 100 according to the present embodiment.

A function of the information processing apparatus 100 according to the present embodiment can be realized by cooperation of software and hardware to be described below. Functions of the overall control unit 120, the instruction analysis unit 130, the image evoking unit 140, the name object registration unit 150, and the robot control unit 160 may be executed by, for example, aCPU 901. A function of the input unit 110 may be executed by, for example, an input device 906, a connection port 910, or a communication device 911.

As illustrated in FIG. 8, the information processing apparatus 100 includes the central processing unit (CPU) 901, a read only memory (ROM) 902, and a random access memory (RAM) 903.

Furthermore, the information processing apparatus 100 may further include a host bus 904a, a bridge 904, an external bus 904b, an interface 905, the input device 906, an output device 907, a storage device 908, a drive 909, the connection port 910, or the communication device 911. The information processing apparatus 100 may include a processing circuit such as a digital signal processor (DSP) or an application specific integrated circuit (ASIC) instead of the CPU 901 or together with the CPU 901.

The CPU 901 functions as an arithmetic processing device or a control device, and controls an operation in the information processing apparatus 100 according to various programs recorded on a removable recording medium attached to the ROM 902, the RAM 903, the storage device 908, or the drive 909. The ROM 902 stores programs, arithmetic parameters, and the like used by the CPU 901. The RAM 903 temporarily stores a program used in execution by the CPU 901, and parameters used during the execution, and the like.

The CPU 901, the ROM 902, and the RAM 903 are mutually connected by the host bus 904a capable of high-speed data transmission. The host bus 904a is connected to the external bus 904b such as a peripheral component interconnect/interface (PCI) bus via the bridge 904, and the external bus 904b is connected to various components via the interface 905.

The input device 906 is, for example, a device that receives an input from a user, such as a mouse, a keyboard, a touch panel, a button, a switch, or a lever. Note that, the input device 906 may be a microphone or the like that detects voice of the user. The input device 906 may be, for example, a remote control device using infrared rays or other radio waves, or may be an external connection device compatible with the manipulation of the information processing apparatus 100.

The input device 906 further includes an input control circuit that outputs an input signal generated on the basis of information input by the user to the CPU 901. The user can input various kinds of data or giving an instruction about a processing operation to the information processing apparatus 100 by manipulating the input device 906.

The output device 907 is a device capable of visually or aurally presenting information acquired or generated by the information processing apparatus 100 to the user. The output device 907 may be, for example, a display device such as a liquid crystal display (LCD), a plasma display panel (PDP), an organic light emitting diode (OLED) display, a hologram, or a projector, may be a sound output device such as a speaker or a headphone, or may be a printing device such as a printer device. The output device 907 can output information obtained by the processing of the information processing apparatus 100, as video such as text or image, and sound such as voice or audio.

The storage device 908 is a data storage device configured as an example of a storage unit of the information processing apparatus 100. The storage device 908 may include, for example, a magnetic storage device such as a hard disk drive (HDD), a semiconductor storage device, an optical storage device, a magneto-optical storage device, or the like. The storage device 908 can store programs executed by the CPU 901, various kinds of data, various kinds of data acquired from the outside, or the like.

The drive 909 is a reading or writing device of a removable recording medium such as a magnetic disk, an optical disk, a magneto-optical disk, or a semiconductor memory, and is built in or externally attached to the information processing apparatus 100. For example, the drive 909 can read information recorded in the attached removable recording medium and output the information to the RAM 903. Furthermore, the drive 909 can write a record in the attached removable recording medium.

The connection port 910 is a port for directly connecting the external connection device to the information processing apparatus 100. The connection port 910 may be, for example, a universal serial bus (USB) port, an IEEE 1394 port, a small computer system interface (SCSI) port, or the like. Furthermore, the connection port 910 may be an RS-232C port, an optical audio terminal, or a high-definition multimedia interface (HDMI (registered trademark)) port, or the like. The connection port 910 is connected to the external connection device, and thus, various kinds of data can be transmitted and received between the information processing apparatus 100 and the external connection device.

The communication device 911 is, for example, a communication interface including a communication device or the like for connecting to the communication network 920. The communication device 911 may be, for example, a communication card for wired or wireless local area network (LAN), Wi-Fi (registered trademark), Bluetooth (registered trademark), or wireless USB (WUSB). Furthermore, the communication device 911 may be a router for optical communication, a router for asymmetric digital subscriber line (ADSL), a modem for various kinds of communication, or the like.

For example, the communication device 911 can transmit and receive signals and the like to and from the Internet or another communication device by using a predetermined protocol such as TCP/IP. Furthermore, the communication network 920 connected to the communication device 911 is a network connected by wire or wirelessly, and may be, for example, an Internet communication network, a home LAN, an infrared communication network, a radio wave communication network, a satellite communication network, or the like.

Note that, it is also possible to create a program for causing hardware such as the CPU 901, the ROM 902, and the RAM 903 built in a computer to exhibit functions equivalent to those of the information processing apparatus 100 described above. Furthermore, a computer-readable recording medium in which the program is recorded can also be provided.

While the preferred embodiments of the present disclosure have been described in detail with reference to the accompanying drawings, the technical scope of the present disclosure is not limited to such examples. It is obvious that those with ordinary skill in the technical field of the present disclosure can conceive various alterations or corrections within the scope of the technical idea recited in the claims, and it is naturally understood that those alterations or corrections also fall within the technical scope of the present disclosure.

Furthermore, the effects described in the present specification are merely exemplary or illustrative, and are not restrictive. In other words, the technology according to the present disclosure may exhibit other effects apparent to those skilled in the art from the description of the present specification, in addition to the effects described above or instead of the effects described above.

Note that, the following configurations also fall within the technological scope of the present disclosure.

### 1

An information processing apparatus including:
an image evoking unit that extracts a registered object from a captured image and outputs an identifier corresponding to the extracted object;
a name object registration unit that registers a correspondence between a name of the object and the identifier; and
an overall control unit that grasps a correspondence between the name included in an instruction text and the object included in the captured image on a basis of the identifier and executes an operation on the object instructed by the instruction text.

### 2

The information processing apparatus according to the above (1), in which, in a case where the instruction by the instruction text is an instruction about giving a name to an object in the captured image, the name object registration unit registers the name included in the instruction text and the identifier output from the image evoking unit to which the captured image is input in association with each other.

### 3

The information processing apparatus according to the above (2), in which, in a case where the object included in the captured image is not registered, the image evoking unit registers the object and outputs a new identifier corresponding to the object.

### 4

The information processing apparatus according to the above (3), in which the object is displayed in the captured image so as to be able to be uniquely specified.

### 5

The information processing apparatus according to any one of the above (2) to (4), in which the name object registration unit associates at least one or more names with one identifier.

### 6

The information processing apparatus according to any one of the above (1) to (5),
in which the name object registration unit outputs the identifier corresponding to the name included in the instruction text, and
the overall control unit grasps the correspondence between the name and the object on a basis of matching between the identifier output from the name object registration unit and the identifier output from the image evoking unit.

### 7

The information processing apparatus according to any one of the above (1) to (6), further including:
an instruction analysis unit that analyzes content of the instruction text.

### 8

The information processing apparatus according to the above (7), in which, in a case where the operation on the object instructed by the instruction text is specified by the instruction analysis unit, the overall control unit causes the operation on the object to be executed on a basis of an analysis result of the instruction analysis unit.

### 9

The information processing apparatus according to any one of the above (1) to (8), in which the overall control unit causes a robot including a manipulator to execute the operation on the object.

### 10

The information processing apparatus according to the above (9), in which the instruction text is generated by performing voice recognition on a voice uttered by a user of the robot.

### 11

An information processing method including:
extracting a registered object from a captured image and outputting an identifier corresponding to the extracted object;
registering a correspondence between a name of the object and the identifier; and
grasping a correspondence between the name included in an instruction text and the object included in the captured image on a basis of the identifier and causing an operation on the object instructed by the instruction text to be executed.

### REFERENCE SIGNS LIST

10 User
20 Robot
30 Object
31 Target object
100 Information processing apparatus
110 Input unit
120 Overall control unit
130 Instruction analysis unit
140 Image evoking unit
150 Name object registration unit
160 Robot control unit
Img1, Img2, Img3 Input image
reg1 Registered image region
Obj2, Obj3 Image region
Txt1, Txt2, Txt3 Instruction text

1. An information processing apparatus comprising:
an image evoking unit that extracts a registered object from a captured image and outputs an identifier corresponding to the extracted object;
a name object registration unit that registers a correspondence between a name of the object and the identifier; and
an overall control unit that grasps a correspondence between the name included in an instruction text and the object included in the captured image on a basis of the identifier and executes an operation on the object instructed by the instruction text.

2. The information processing apparatus according to claim 1, wherein, in a case where the instruction by the instruction text is an instruction about giving a name to an object in the captured image, the name object registration unit registers the name included in the instruction text and the identifier output from the image evoking unit to which the captured image is input in association with each other.

3. The information processing apparatus according to claim 2, wherein, in a case where the object included in the captured image is not registered, the image evoking unit registers the object and outputs a new identifier corresponding to the object.

4. The information processing apparatus according to claim 3, wherein the object is displayed in the captured image so as to be able to be uniquely specified.

5. The information processing apparatus according to claim 2, wherein the name object registration unit associates at least one or more names with one identifier.

6. The information processing apparatus according to claim 1,
wherein the name object registration unit outputs the identifier corresponding to the name included in the instruction text, and
the overall control unit grasps the correspondence between the name and the object on a basis of matching between the identifier output from the name object registration unit and the identifier output from the image evoking unit.

7. The information processing apparatus according to claim 1, further comprising: an instruction analysis unit that analyzes content of the instruction text.

8. The information processing apparatus according to claim 7, wherein, in a case where the operation on the object instructed by the instruction text is specified by the instruction analysis unit, the overall control unit causes the operation on the object to be executed on a basis of an analysis result of the instruction analysis unit.

9. The information processing apparatus according to claim 1, wherein the overall control unit causes a robot including a manipulator to execute the operation on the object.

10. The information processing apparatus according to claim 9, wherein the instruction text is generated by performing voice recognition on a voice uttered by a user of the robot.

11. An information processing method comprising:
extracting a registered object from a captured image and outputting an identifier corresponding to the extracted object;
registering a correspondence between a name of the object and the identifier; and
grasping a correspondence between the name included in an instruction text and the object included in the captured image on a basis of the identifier and causing an operation on the object instructed by the instruction text to be executed.
